(19) United States
(12) Patent Application Publication
(10) Pub. No.: US 2025/0046783 A1
(43) Pub. Date: Feb. 6, 2025

(54) CURRENT COLLECTOR WITH ANCHORING INTERFACE LAYER

(71) Applicant: NISSAN NORTH AMERICA, INC., Franklin, TN (US)

(72) Inventor: Mohammed Hussain ABDUL JABBAR, Novi, MI (US)

(21) Appl. No.: 18/362,502

(22) Filed: Jul. 31, 2023

(51) Int. Cl. H01M 4/131; H01M 4/38; H01M 4/66

(52) U.S. Cl. CPC H01M 4/131; H01M 4/382; H01M 4/661; H01M 2004/021; H01M 10/052; H01M 2300/0082

(57) ABSTRACT

An electrode is provided that includes a current collector, an electrode active material layer and an interface layer disposed between the current collector and the electrode active material layer. The electrode active material layer includes an electrode active material including lithium. The interface layer includes a transition metal oxide including oxygen and at least one transition metal. The interface layer also has a surface in contact with the electrode active material layer and at least one recess formed in the surface.

### BACKGROUND

### Field of the Invention

The present invention generally relates to a current collector having an interface layer for anchoring an active material to the current collector in a lithium-ion battery, and a lithium-ion battery including the current collector with the anchoring interface layer. The electrode includes a current collector, an electrode active material layer and an interface layer disposed between the current collector and the electrode active material layer. The electrode active material layer includes an electrode active material including lithium. The interface layer includes a transition metal oxide including oxygen and at least one transition metal. The interface layer also has a surface in contact with the electrode active material layer and at least one recess formed in the surface.

### Background Information

Lithium-ion batteries that include lithium metal anodes or lithium-based cathode materials are desirable because they have a high energy density and, thus, can generate a large amount of power with a relatively thin electrode structure, thus permitting a reduction in the size of the battery as compared with other conventional batteries including anodes made of carbon or silicon. Lithium-ion batteries use lithium metal anodes and cathodes formed of complex oxides such as lithium nickel manganese cobalt oxide (LiNiMnCoO₂, also commonly referred to as “NMC”). The lithium metal anodes typically include copper current collectors, and the cathodes typically include aluminum current collectors.

However, there are several drawbacks with conventional lithium-ion batteries. For example, the performance of lithium metal anodes is limited by current density as such anodes are prone to excessive dendritic growth and accumulation of dead lithium resulting in severe volume expansion of lithium metal anodes in the battery. The lithium metal anode active material also undergoes undesirable reactions with the copper current collector. This results in weak bonding and electrode resistive losses. Furthermore, the interface of the lithium metal active material layer and the copper current collector has weak adhesion, resulting in delamination of the anode active material layer from the anode current collector. Similar adhesion issues can also occur between the cathode active material year and the cathode current collector.

In order to improve the safety and energy storage capacity of lithium-based batteries, solid-state batteries have been developed that use a solid or polymer electrolyte to conduct lithium ions between the anode and cathode. Solid-state batteries allow for a much smaller battery size due to their improved energy density. Solid state lithium-based batteries also have an improved safety performance, an enhanced life cycle and higher charge/discharge rates as compared with conventional lithium-ion batteries using a liquid electrolyte, which can lead to undesirable dendrite formation and short-circuiting. However, conventional solid-state batteries have an increased ohmic resistance due to the poor contact between the current collectors and the electrode materials.

Therefore, further improvement is needed to sufficiently reduce the ohmic resistance and overall performance of the lithium-ion battery. In particular, it is desirable to increase the adhesion between the electrode current collectors and the electrode materials and thereby decrease the ohmic resistance of the battery. It is also desirable to prevent excessive dendritic growth caused by unwanted reactions between the lithium and the current collector materials.

### SUMMARY

It has been discovered that the adhesion between the anode or cathode current collector and the respective electrode active material can be improved by providing a thin interface layer between the current collector and the electrode active material and by forming a recess in the surface of the interface layer. It has also been discovered that undesirable reactions between the electrode active material and the current collector can be reduced by forming the interface layer of a lithiophilic transition metal oxide material.

In particular, it has been discovered that the performance and safety of the battery can be improved by providing an interface layer formed of a lithiophilic material, such as a transition metal oxide, between the current collector and the electrode active material layer. The lithiophilic material improves the wettability of the current collector and the lithium-containing electrode active material and acts as a barrier layer to prevent potential reactions between the current collector material, for example copper, and the lithium in the electrode active material. By preventing unwanted reactions between the metal of the current collector (i.e., copper) and the lithium in the electrode active material, the lithiophilic material prevents dendrite growth and thereby improves battery safety.

It has also been discovered that the adhesion of the electrode active material to the current collector can be improved by providing at least one recess or groove in the surface of the interface layer, thereby anchoring the lithium in the electrode active material to the copper or aluminum of the current collector. This in turn enhances the cyclability of the battery, lowers the resistance of the battery and improves the battery performance. Therefore, it is desirable to provide a solid state battery that includes such an interface layer on the anode and/or cathode current collector.

In view of the state of the known technology, one aspect of the present disclosure is to provide an electrode including a current collector with an anchoring interface layer. The electrode includes a current collector, an electrode active material layer, and an interface layer disposed between the current collector and the electrode active material layer. The electrode active material layer includes an electrode active material including lithium. The interface layer includes a transition metal oxide including oxygen and at least one transition metal. The interface layer also has a surface in contact with the electrode active material layer and at least one recess formed in the surface.

Another aspect of the present disclosure is to provide a battery including a current collector with an anchoring interface layer. The battery includes a cathode, an anode, and an electrolyte disposed between the cathode and the anode. At least one of the anode and the cathode includes: a current collector, an electrode active material layer, and an interface layer disposed between the current collector and the electrode active material layer. The electrode active material layer includes an electrode active material including lithium. The interface layer includes a transition metal oxide including oxygen and at least one transition metal. The interface layer also has a surface in contact with the electrode active material layer and at least one recess formed in the surface.

By providing the interface layer between the current collector and the electrode active material, unwanted reactions between the current collector and the lithium in the electrode active material can be reduced, thereby preventing dendrite growth and improving the safety and performance of the battery. Furthermore, by providing at least one recess in the surface of the interface layer, the adhesion between the current collector and the lithium can be improved, thus preventing undesirable peeling off of the electrode active material layer from the current collector and decreasing the resistance while improving the cyclability of the battery.

### BRIEF DESCRIPTION OF THE DRAWINGS

Referring now to the attached drawings which form a part of this original disclosure:

FIG. 1 is a cross sectional view of a solid state battery according to one embodiment;

FIG. 2 is a top perspective view of an interface layer for a current collector according to an embodiment;

FIG. 3(a) is a cross sectional view of a solid state battery before cycling according to one embodiment;

FIG. 3(b) is a cross sectional view of the solid state battery of FIG. 3(a) after cycling;

FIG. 5 is a cross sectional view of an electrode according to one embodiment; and

FIG. 6 is a top perspective view of an interface layer for a current collector according to an embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

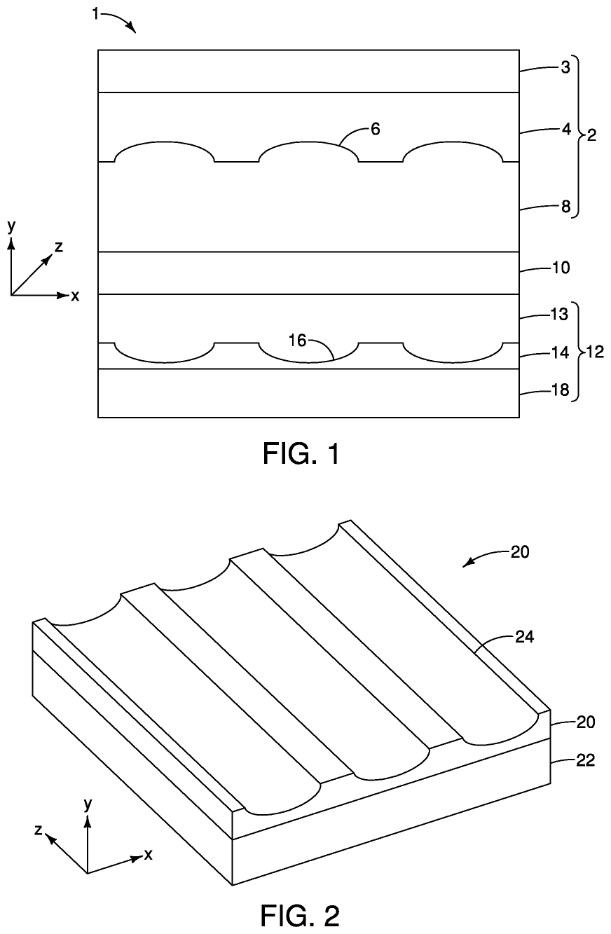

Referring initially to FIG. 1, a solid-state battery 1 is illustrated that includes a cathode 2, an electrolyte 10, and an anode 12 in accordance with a first embodiment. The solid-state battery 1 can be incorporated in a vehicle, a mobile device, a laptop computer or other suitable personal electronic device. The solid-state battery 1 is preferably an all-solid-state battery.

As shown in FIG. 1, the cathode 2 includes a cathode current collector 3, a cathode interface layer 4 formed on the bottom surface of the cathode current collector 3, and a cathode active material layer 8 that is provided on the bottom surface of the cathode interface layer 4 such that the cathode interface layer 4 is provided between the cathode current collector 3 and the cathode active material layer 8.

The cathode current collector 3 is formed of any suitable metal material, such as aluminum or copper, preferably aluminum. The cathode current collector 3 has a thickness ranging from 5 μm to 25 μm, preferably 10 μm to 12 μm.

As shown in FIG. 1, the cathode interface layer 4 is formed on the bottom surface of the cathode current collector 3 facing the electrolyte 10. The cathode interface layer 4 can be formed on the cathode current collector 3 in any suitable manner, for example by spraying, electrodeposition or any other suitable deposition method. The cathode interface layer 4 is formed of a lithiophilic material. For example, the cathode interface layer 4 can be formed of a lithiophilic transition metal oxide or a mixture of lithiophilic transition metal oxides. The cathode interface layer 4 is preferably formed of aluminum oxide (Al₂O₃). The cathode interface layer 4 has a thickness of 5 nm to 1 μm, preferably 5 nm to 10 nm.

The cathode interface layer 4 includes a plurality of recesses 6 formed in the bottom surface facing the cathode active material layer 8 as shown in FIG. 1. The recesses 6 are formed as grooves or channels in the bottom surface of the cathode interface layer 4. The recesses 6 can be formed by photolithography or etching in the bottom surface of the cathode interface layer 4. However, it should be understood that the recesses 6 can be formed in any suitable manner.

The recesses 6 are spaced apart from each other and each extend along the bottom surface of the cathode interface layer 4 in the z direction. For example, the recesses 6 can be formed as channels that extend along the entire length of the cathode interface layer 4 in the z direction. However, it should be understood that the recesses 6 can be formed in any suitable pattern in order to improve adhesion with the cathode active material layer 8.

Each of the recesses 6 has a same prescribed width in the x direction and a same prescribed depth in the y direction from a bottom surface of the cathode interface layer 4 that faces the cathode active material layer 8. For example, each of the recesses 6 has a prescribed width and depth of about 5% to 10% of the total thickness of the cathode interface layer 4. However, it should be understood that the recesses 6 can have different widths and different depths from the bottom surface of the cathode interface layer 4, as long as each of the recesses 6 has a prescribed width and depth of about 5% to 10% of the thickness of the cathode interface layer 4. Preferably, each of the recesses 6 has a prescribed width and depth of 0.25 nm to 100 nm. The distance between each of the recesses 6 in the x direction ranges from 0.25 nm to 100 nm.

The cathode active material layer 8 includes a cathode active material. The cathode active material is any suitable cathode active material that is compatible with a solid electrolyte. For example, the cathode active material can be a lithium transition metal oxide such as NMC or lithium cobalt oxide, lithium phosphate, LiFePO₄ or a mixture thereof.

The cathode active material layer 8 can also include an additive (such as sacrificial cathode materials that acts as an additional source of lithium ions) and/or a binder. The cathode active material layer 8 includes at least 80 percent by weight of the cathode active material, preferably at least 90 percent by weight of the cathode active material. The cathode active material layer 8 also includes up to five percent by weight of the additive plus the binder. For example, the cathode active material layer 8 can include approximately two percent by weight of the additive and approximately three percent by weight of the binder. The weight percentage values described above are relative to a total weight of the cathode active material layer 8.

The binder can be any suitable electrode binder material. For example, the binder can include polyvinylidene fluoride, styrene-butadiene rubber, a cellulose material or any combination thereof. The additive can be any suitable sacrificial electrode additive, such as a material that acts as an additional source of lithium ions.

The cathode active material layer 8 preferably includes a mixture of NMC, an electron conducting material such as carbon and a lithium-ion conductive material such as a sulfide electrolyte. As shown in FIG. 1, the cathode active material layer 8 is in contact with the bottom surface of the cathode interface layer 4 and is provided within the recesses 6. The cathode active material layer 8 is also in contact with the top surface of the electrolyte 10 such that the cathode active material layer 8 is provided between the cathode interface layer 4 and the electrolyte 10. The cathode active material layer 8 has a thickness ranging from 1 μm to 25 μm, preferably 5 μm to 10 μm.

By providing the cathode interface layer 4, unwanted reactions between the cathode current collector 3 and lithium in the cathode active material layer 8 can be reduced, thereby preventing dendrite growth and improving the safety and performance of the battery 1. Furthermore, by providing the recesses 6 in the bottom surface of the cathode interface layer 4, adhesion between the cathode current collector 3 and the cathode active material layer 8 can be improved, thus preventing undesirable peeling off of the cathode active material layer 8 and decreasing the resistance of the battery 1.

The electrolyte 10 is any suitable electrolyte for a solid-state battery, such as a solid electrolyte or a polymer electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a polyethylene oxide (“PEO”) based polymer. The electrolyte 10 has a thickness of approximately 10 μm to 20 μm, preferably 5 μm to 10 μm.

As shown in FIG. 1, the anode 12 includes an anode active material layer 13, an anode interface layer 14, and an anode current collector 18 that is provided on the bottom surface of the anode interface layer 14 such that the anode interface layer 14 is provided between the anode active material layer 13 and the anode current collector 18.

The anode active material layer 13 includes an anode active material. The anode active material is any suitable lithium-based anode active material that is compatible with a solid electrolyte. For example, the anode active material is formed of lithium metal or a lithium alloy. The anode active material is preferably lithium metal.

The anode active material layer 13 can also include an additive and/or a binder. The anode active material layer 13 includes approximately 90-95 percent by weight of the anode active material and five to ten percent by weight of the additive plus the binder. For example, the anode active material layer 13 can include approximately 95.0 percent by weight of the anode active material, 2.5 percent by weight of the additive and 2.5 percent by weight of the binder.

The binder can be any suitable electrode binder material. For example, the binder can include polyvinylidene fluoride, styrene-butadiene rubber, a cellulose material or any combination thereof. The additive can be any suitable sacrificial electrode additive, such as a material that acts as an additional source of lithium ions.

When a sulfide-based solid electrolyte is used as the electrolyte 10 and the anode active material layer 13 includes lithium metal, a protective layer (not shown) can also be provided between the electrolyte 10 and the anode 12.

As shown in FIG. 1, the anode interface layer 14 is provided on the top surface of the anode current collector 18 facing the electrolyte 10. The anode interface layer 14 can be formed on the anode current collector 18 in any suitable manner, for example by spraying, electrodeposition or any other suitable deposition method. The anode interface layer 14 is formed of a lithiophilic material. For example, the anode interface layer 14 can be formed of a lithiophilic transition metal oxide or a mixture of lithiophilic transition metal oxides. The anode interface layer 14 is preferably formed of zinc oxide and/or zirconium oxide. The anode interface layer 14 has a thickness ranging from 10 nm to 2 μm, preferably 250 nm to 500 nm.

The anode interface layer 14 includes a plurality of recesses 16 formed in the top surface facing the anode active material layer 13 as shown in FIG. 1. The recesses 6 are formed as grooves or channels in the top surface of the anode interface layer 14. The recesses 16 can be formed by photolithography or etching in the top surface of the anode interface layer 4. However, it should be understood that the recesses 16 can be formed in any suitable manner.

The recesses 16 are spaced apart from each other and each extend along the top surface of the anode interface layer 14 in the z direction. For example, the recesses 16 can be formed as channels that extend along the entire length of the anode interface layer 14 in the z direction. However, it should be understood that the recesses 16 can be formed in any suitable pattern and can extend along any suitable length of the anode interface layer 14 in order to improve adhesion with the anode active material layer 13.

Each of the recesses 16 has a same prescribed width in the x direction and a same prescribed depth in the y direction from a top surface of the anode interface layer 14 that faces the anode active material layer 13. For example, each of the recesses 16 has a prescribed width and depth of about 5% to 10% of the total thickness of the anode interface layer 14. However, it should be understood that the recesses 16 can have different widths and different depths from the top surface of the anode interface layer 14, as long as each of the recesses 16 has a prescribed width and depth of about 5% to 10% of the thickness of the anode interface layer 14. Preferably, each of the recesses 16 has a prescribed width and depth of 0.5 nm to 200 nm. The distance between each of the recesses 16 in the x direction ranges from 0.5 nm to 200 nm.

The anode current collector 18 is formed of any suitable metal material, such as aluminum or copper, preferably copper. The anode current collector 18 has a thickness ranging from 5 μm to 25 μm, preferably 10 μm to 12 μm.

By providing the anode interface layer 14, unwanted reactions between the copper in the anode current collector 18 and lithium in the anode active material layer 13 can be reduced, thereby preventing dendrite growth and improving the safety and performance of the battery 1. Furthermore, by providing the recesses 16 in the top surface of the anode interface layer 14, adhesion between the anode current collector 18 and the anode active material layer 13 can be improved, thus preventing undesirable peeling off of the anode active material layer 13 and decreasing the resistance of the battery 1.

FIG. 2 shows an interface layer 20 for a current collector 22 of a solid-state battery in accordance with a second embodiment. The interface layer 20 can be formed on the current collector 22 in any suitable manner, for example by spraying, electrodeposition or any other suitable deposition method. The interface layer 20 is formed of a lithiophilic material. For example, the interface layer 20 can be formed of a lithiophilic transition metal oxide or a mixture of lithiophilic transition metal oxides. When the current collector 22 is an anode current collector, the interface layer 20 is preferably formed of zinc oxide and/or zirconium oxide. Alternatively, when the current collector 22 is a cathode current collector, the interface layer 20 is preferably formed of aluminum oxide. The interface layer 20 has a thickness ranging from 10 nm to 2 μm, preferably 250 nm to 500 nm.

The current collector 22 is formed of any suitable metal material, such as aluminum or copper. For example, if the current collector 22 is an anode current collector, the current collector 22 is formed of copper. If the current collector 22 is a cathode current collector, the current collector 22 is formed of aluminum. The current collector 22 has a thickness ranging from 5 μm to 25 μm, preferably 10 μm to 12 μm.

As shown in FIG. 2, the interface layer 20 includes a plurality of recesses 24 formed in the top surface of the interface layer 20. The recesses 24 are formed as grooves or channels in the top surface of the interface layer 20. The recesses 24 can be formed by photolithography or etching in the top surface of the interface layer 20. However, it should be understood that the recesses 24 can be formed in any suitable manner.

The recesses 24 are spaced apart from each other and each extend along the top surface of the interface layer 20 in the z direction. For example, as shown in FIG. 2, the recesses 24 are formed as channels that extend along the entire length of the interface layer 20 in the z direction. However, it should be understood that the recesses 24 can be formed in any suitable pattern and can extend along any suitable length of the interface layer 20.

Each of the recesses 24 has a same prescribed width in the x direction and a same prescribed depth in the y direction from a top surface of the interface layer 20. For example, each of the recesses 24 has a prescribed width and depth of about 5% to 10% of the total thickness of the interface layer 20. However, it should be understood that the recesses 24 can have different widths and different depths from the top surface of the interface layer 20, as long as each of the recesses 24 has a prescribed width and depth of about 5% to 10% of the thickness of the interface layer 20. Preferably, each of the recesses 24 has a prescribed width and depth of 0.5 nm to 200 nm. The distance between each of the recesses 24 in the x direction ranges from 0.5 nm to 200 nm.

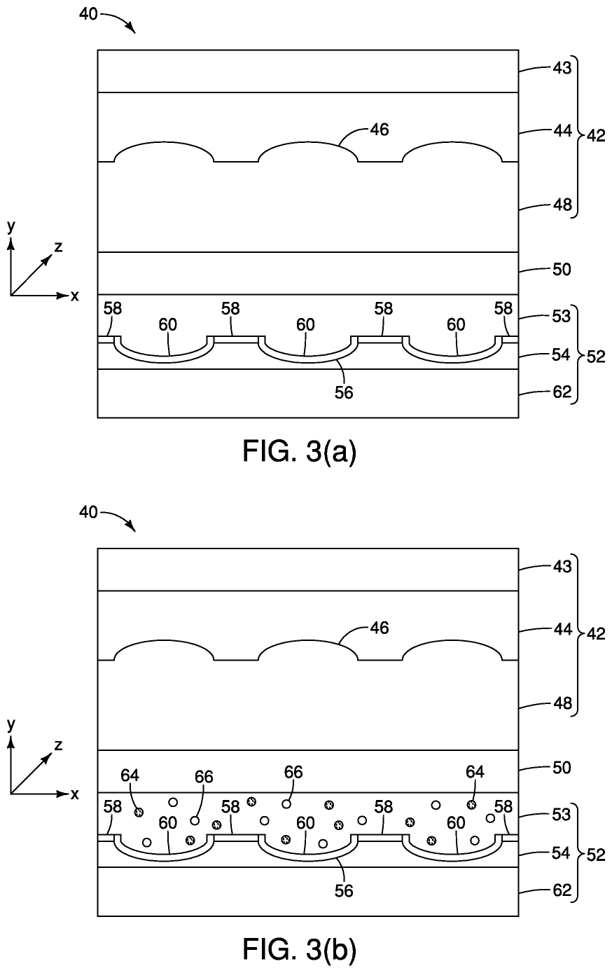

FIGS. 3(a) and 3(b) show a solid-state battery 40 that includes a cathode 42, an electrolyte 50, and an anode 52 in accordance with a third embodiment. FIG. 3(a) shows the solid-state battery 40 before cycling, and FIG. 3(b) shows the solid-state battery 40 after cycling. Like the solid-state battery of the first embodiment, the solid-state battery 40 is preferably an all-solid-state battery and can be incorporated in a vehicle, a mobile device, a laptop computer or other suitable personal electronic devices.

As shown in FIGS. 3(a) and 3(b), the cathode 42 includes a cathode current collector 43, a cathode interface layer 44 formed on the bottom surface of the cathode current collector 43, and a cathode active material layer 48 that is provided on the bottom surface of the cathode interface layer 44 such that the cathode interface layer 44 is provided between the cathode current collector 43 and the cathode active material layer 48.

The cathode current collector 43 is formed of any suitable metal material, such as aluminum or copper, preferably aluminum. The cathode current collector 43 has a thickness ranging from 5 μm to 25 μm, preferably 10 μm to 12 μm.

As shown in FIGS. 3(a) and 3(b), the cathode interface layer 44 is formed on the bottom surface of the cathode current collector 43 facing the electrolyte 50. The cathode interface layer 44 can be formed on the cathode current collector 43 in any suitable manner, for example by spraying, electrodeposition or any other suitable deposition method. The cathode interface layer 44 is formed of a lithiophilic material. For example, the cathode interface layer 44 can be formed of a lithiophilic transition metal oxide or a mixture of lithiophilic transition metal oxides. The cathode interface layer 44 is preferably formed of aluminum oxide. The cathode interface layer 44 has a thickness of 5 nm to 1 μm, preferably 5 nm to 10 nm.

The cathode interface layer 44 includes a plurality of recesses 46 formed as grooves or channels in the bottom surface of the cathode interface layer 44. The recesses 46 can be formed by photolithography or etching. However, it should be understood that the recesses 46 can be formed in any suitable manner.

The recesses 46 are spaced apart from each other and each extend along the bottom surface of the cathode interface layer 44 in the z direction. For example, the recesses 46 can be formed as channels that extend along the entire length of the cathode interface layer 44 in the z direction. However, it should be understood that the recesses 46 can be formed in any suitable pattern or extend any suitable length in order to improve adhesion with the cathode active material layer 48.

Each of the recesses 46 has a same prescribed width in the x direction and a same prescribed depth in the y direction from the bottom surface of the cathode interface layer 44. For example, each of the recesses 46 has a prescribed width and depth of about 5% to 10% of the total thickness of the cathode interface layer 44. However, it should be understood that the recesses 46 can have different widths and different depths from the bottom surface of the cathode interface layer 44, as long as each of the recesses 46 has a prescribed width and depth of about 5% to 10% of the thickness of the cathode interface layer 44. Preferably, each of the recesses 46 has a prescribed width and depth of 0.25 nm to 100 nm. The distance between each of the recesses 46 in the x direction ranges from 0.25 nm to 100 nm.

The cathode active material layer 48 includes a cathode active material. The cathode active material is any suitable cathode active material that is compatible with a solid electrolyte. For example, the cathode active material can be a lithium transition metal oxide such as NMC or lithium cobalt oxide, lithium phosphate, LiFePO₄ or a mixture thereof.

The cathode active material layer 48 can also include an additive (such as sacrificial cathode materials that acts as an additional source of lithium ions) and/or a binder. The cathode active material layer 48 includes at least 80 percent by weight of the cathode active material, preferably at least 90 percent by weight of the cathode active material. The cathode active material layer 48 also includes up to five percent by weight of the additive plus the binder. For example, the cathode active material layer 48 can include approximately two percent by weight of the additive and approximately three percent by weight of the binder. The weight percentage values described above are relative to a total weight of the cathode active material layer 48.

The binder can be any suitable electrode binder material. For example, the binder can include polyvinylidene fluoride, styrene-butadiene rubber, a cellulose material or any combination thereof. The additive can be any suitable sacrificial electrode additive, such as a material that acts as an additional source of lithium ions.

The cathode active material layer 48 preferably includes a mixture of NMC, an electron conducting material such as carbon and a lithium-ion conductive material such as a sulfide electrolyte. As shown in FIGS. 3(a) and 3(b), the cathode active material layer 48 is in contact with the bottom surface of the cathode interface layer 44 and is provided within the recesses 46. The cathode active material layer 48 is also in contact with the top surface of the electrolyte 50 such that the cathode active material layer 48 is provided between the cathode interface layer 44 and the electrolyte 50. The cathode active material layer 48 has a thickness ranging from 1 μm to 25 μm, preferably 5 μm to 10 μm.

By providing the cathode interface layer 44, unwanted reactions between the cathode current collector 43 and lithium in the cathode active material layer 48 can be reduced, thereby preventing dendrite growth and improving the safety and performance of the battery 40. Furthermore, by providing the recesses 46 in the bottom surface of the cathode interface layer 44, adhesion between the cathode current collector 43 and the cathode active material layer 48 can be improved, thereby preventing the cathode active material layer 8 from peeling off of the cathode current collector 43 while also decreasing the resistance of the battery 40 and improving the cyclability and overall performance of the battery 40.

The electrolyte 50 is any suitable electrolyte for a solid-state battery, such as a solid electrolyte or a polymer electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a PEO based polymer. The electrolyte 50 has a thickness of approximately 10 μm to 20 μm, preferably 5 μm to 10 μm.

As shown in FIGS. 3(a) and 3(b), the anode 52 includes an anode active material layer 53, an anode interface layer 54, and an anode current collector 62 that is provided on the bottom surface of the anode interface layer 54 such that the anode interface layer 54 is provided between the anode active material layer 53 and the anode current collector 58.

The anode active material layer 53 includes an anode active material. The anode active material is any suitable lithium-based anode active material that is compatible with a solid electrolyte. For example, the anode active material is formed of lithium metal or a lithium alloy. The anode active material is preferably lithium metal.

The anode active material layer 53 can also include an additive and/or a binder. The anode active material layer 53 includes approximately 90-95 percent by weight of the anode active material and five to ten percent by weight of the additive plus the binder. For example, the anode active material layer 53 can include approximately 95.0 percent by weight of the anode active material, 2.5 percent by weight of the additive and 2.5 percent by weight of the binder.

The binder can be any suitable electrode binder material. For example, the binder can include polyvinylidene fluoride, styrene-butadiene rubber, a cellulose material or any combination thereof. The additive can be any suitable sacrificial electrode additive, such as a material that acts as an additional source of lithium ions.

When a sulfide-based solid electrolyte is used as the electrolyte 50 and the anode active material layer 53 includes lithium metal, a protective layer (not shown) can also be provided between the electrolyte 50 and the anode 52.

As shown in FIGS. 3(a) and 3(b), the anode interface layer 54 is provided on the top surface of the anode current collector 58 facing the electrolyte 50. The anode interface layer 54 can be formed on the anode current collector 58 in any suitable manner, for example by spraying, electrodeposition or any other suitable deposition method. The anode interface layer 54 is formed of a lithiophilic material. For example, the anode interface layer 54 can be formed of a lithiophilic transition metal oxide or a mixture of lithiophilic transition metal oxides. The anode interface layer 54 is preferably formed of zinc oxide and/or zirconium oxide. The anode interface layer 54 has a thickness ranging from 10 nm to 2 μm, preferably 250 nm to 500 nm.

The anode interface layer 54 includes a plurality of recesses 56 formed in the top surface facing the anode active material layer 53. The recesses 56 are formed as grooves or channels in the top surface of the anode interface layer 54. The recesses 56 can be formed by photolithography or etching in the top surface of the anode interface layer 54. However, it should be understood that the recesses 56 can be formed in any suitable manner.

The recesses 56 are spaced apart from each other and each extend along the top surface of the anode interface layer 54 in the z direction. For example, the recesses 56 can be formed as channels that extend along the entire length of the anode interface layer 54 in the z direction. However, it should be understood that the recesses 56 can be formed in any suitable pattern and can extend along any suitable length of the anode interface layer 54 in order to improve adhesion with the anode active material layer 53.

Each of the recesses 56 has a same prescribed width in the x direction and a same prescribed depth in the y direction from the top surface of the anode interface layer 54. For example, each of the recesses 56 has a prescribed width and depth of about 5% to 10% of the total thickness of the anode interface layer 54. However, it should be understood that the recesses 56 can have different widths and different depths from the top surface of the anode interface layer 54, as long as each of the recesses 56 has a prescribed width and depth of about 5% to 10% of the thickness of the anode interface layer 54. Preferably, each of the recesses 56 has a prescribed width and depth of 0.5 nm to 200 nm. The distance between each of the recesses 56 in the x direction ranges from 0.5 nm to 200 nm.

As shown in FIG. 3(a), before cycling the anode interface layer 54 includes a first dopant layer 58 and a second dopant layer 60. The first dopant layer 58 is formed on the flat portion of the top surface of the anode interface layer 54 between each of the recesses 56. The first dopant layer 58 can be formed of any suitable noble metal that forms an alloy with lithium during cycling of the solid-state battery 40. For example, the first dopant layer 58 can be formed of gold or silver. The first dopant layer 58 is preferably formed of gold. The first dopant layer 58 has a thickness of approximately 1 nm to 10 nm.

The second dopant layer 60 is formed on the surface of the recesses 56 in the anode interface layer 54. The second dopant layer 60 can be formed of any suitable transition metal that forms an alloy with lithium during cycling of the solid-state battery. The second dopant layer 60 is preferably formed of zinc. The second dopant layer 60 has a thickness of approximately 1 nm to 10 nm.

As shown in FIG. 3(b), after cycling the metals in the first dopant layer 58 and the second dopant layer 60 are released such that the metals in the dopant layers 58, 60 dope the lithium in the anode active material layer 53. In particular, the noble metal in the first dopant layer 58 is released as noble metal particles 64 into the anode active material layer 53. Similarly, the transition metal in the second dopant layer 60 is released as transitional metal particles 66 into the anode active material 53. The noble metal particles 64 and the transition metal particles 60 form alloys with the lithium in the anode active material layer 53.

The anode current collector 62 is formed of any suitable metal material, such as aluminum or copper, preferably copper. The anode current collector 62 has a thickness ranging from 5 μm to 25 μm, preferably 10 μm to 12 μm.

By providing the anode interface layer 54, unwanted reactions between the copper in the anode current collector 62 and lithium in the anode active material layer 53 can be reduced, thereby preventing dendrite growth and improving the safety and performance of the battery 40. Furthermore, by providing the recesses 56 in the top surface of the anode interface layer 54, adhesion between the anode current collector 62 and the anode active material layer 53 can be improved, thereby preventing undesirable peeling off of the anode active material layer 53 while simultaneously decreasing the resistance and improving the overall performance of the battery 40. In addition, by further providing the first and second dopant layers 58, 60, dendrite growth can be reduced to a greater degree to further improve the cyclability and performance of the battery 40.

FIG. 4 shows an electrode 80 for a solid-state battery in accordance with a fourth embodiment. Like the solid-state battery of the first and third embodiments, the solid-state battery is preferably an all-solid-state battery and can be incorporated in a vehicle, a mobile device, a laptop computer or other suitable personal electronic devices.

As shown in FIG. 4, the electrode 80 includes a current collector 82, an interface layer 84 formed on the top surface of the current collector, and an electrode active material layer 92. The interface layer 84 is provided between the current collector 82 and the electrode active material layer 92.

The current collector 82 is formed of any suitable metal material, such as aluminum or copper, preferably copper. The current collector 82 has a thickness ranging from 5 μm to 25 μm, preferably 10 μm to 12 μm.

As shown in FIG. 4, the interface layer 84 is provided on the top surface of the current collector 82 facing the electrode active material layer 92. The interface layer 84 can be formed on the current collector 82 in any suitable manner, for example by spraying, electrodeposition or any other suitable deposition method. The interface layer 84 can be formed of a lithiophilic transition metal oxide or a mixture thereof.

When the electrode 80 is an anode, the interface layer 84 is preferably formed of zinc oxide and/or zirconium oxide. However, when the electrode 80 is a cathode, the interface layer 84 is preferably formed of aluminum oxide. The interface layer 84 has a thickness ranging from 10 nm to 2 μm, preferably 250 nm to 500 nm.

The interface layer 84 includes a plurality of recesses 86 formed in the top surface facing the electrode active material layer 92 as shown in FIG. 4. The recesses 86 are formed as grooves or channels in the top surface of the interface layer 84. The recesses 86 can be formed by photolithography or etching in the top surface of the interface layer 84. However, it should be understood that the recesses 86 can be formed in any suitable manner.

The recesses 86 are spaced apart from each other and each extend along the top surface of the interface layer 84 in the z direction. For example, the recesses 86 can be formed as channels that extend along the entire length of the interface layer 84 in the z direction. However, it should be understood that the recesses 86 can be formed in any suitable pattern and can extend along any suitable length of the interface layer 84 in order to improve adhesion with the electrode active material layer 92.

Each of the recesses 86 has a same prescribed width in the x direction and a same prescribed depth in the y direction from the top surface of the interface layer 84. For example, each of the recesses 86 has a prescribed width and depth of about 5% to 10% of the total thickness of the electrode interface layer 84. However, it should be understood that the recesses 86 can have different widths and different depths from the top surface of the interface layer 84, as long as each of the recesses 86 has a prescribed width and depth of about 5% to 10% of the thickness of the interface layer 84. Preferably, each of the recesses 16 has a prescribed width and depth of 0.5 nm to 200 nm. The distance between each of the recesses 16 in the x direction ranges from 0.5 nm to 200 nm.

As shown in FIG. 4, the interface layer 84 includes a first dopant layer 88 and a second dopant layer 90. The first dopant layer 88 is formed on the flat portion of the top surface of the interface layer 84 between each of the recesses 86. The first dopant layer 88 can be formed of any suitable noble metal that forms an alloy with lithium during cycling of the solid-state battery. For example, the first dopant layer 88 can be formed of gold or silver. The first dopant layer 88 is preferably formed of gold. The first dopant layer 88 has a thickness of approximately 1 nm to 10 nm.

The second dopant layer 90 is formed on the surface of the recesses 86 in the interface layer 84. The second dopant layer 90 can be formed of any suitable transition metal that forms an alloy with lithium during cycling of the solid-state battery. The second dopant layer 90 is preferably formed of zinc. The second dopant layer 90 has a thickness of approximately 1 nm to 10 nm.

The electrode active material layer 92 includes an electrode active material. The electrode active material is any suitable lithium-based cathode or anode active material that is compatible with a solid electrolyte. The electrode active material is preferably an anode active material formed of lithium metal or a lithium alloy. The electrode active material is preferably lithium metal.

The electrode active material layer 92 can also include an additive and/or a binder. The electrode active material layer 92 includes approximately 90-95 percent by weight of the electrode active material and five to ten percent by weight of the additive plus the binder. For example, the electrode active material layer 92 can include approximately 95.0 percent by weight of the anode active material, 2.5 percent by weight of the additive and 2.5 percent by weight of the binder.

The binder can be any suitable electrode binder material. For example, the binder can include polyvinylidene fluoride, styrene-butadiene rubber, a cellulose material or any combination thereof. The additive can be any suitable sacrificial electrode additive, such as a material that acts as an additional source of lithium ions.

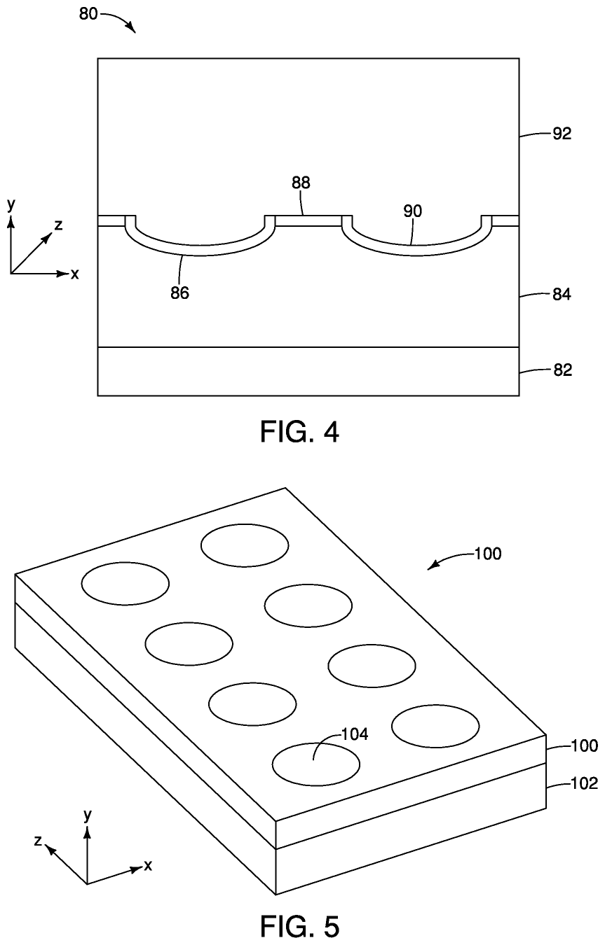

FIG. 5 shows an interface layer 100 for a current collector 102 of a solid-state battery in accordance with a fifth embodiment. The current collector 102 is formed of any suitable metal material, such as aluminum or copper. For example, if the current collector 102 is used as an anode current collector, the current collector 102 is formed of copper. If the current collector 102 is used as a cathode current collector, the current collector 102 is formed of aluminum. The current collector 102 has a thickness ranging from 5 μm to 25 μm, preferably 10 μm to 12 μm.

The interface layer 100 includes a plurality of recesses 104 formed in the top surface of the interface layer 100. The recesses 104 are formed as discrete holes in the top surface of the interface layer 100. The recesses 104 can be formed by photolithography or etching in the top surface of the interface layer 100. However, it should be understood that the recesses 104 can be formed in any suitable manner.

The recesses 104 are spaced apart from each other and are formed in a pattern along the length of the top surface of the interface layer 100 in the z direction. It should be understood that the recesses 104 can be formed in any suitable pattern and can extend along any suitable length of the interface layer 100.

Each of the recesses 104 has a same prescribed width in the x direction and a same prescribed depth in the y direction from a top surface of the interface layer 100. For example, each of the recesses 104 has a prescribed width and depth of about 5% to 10% of the total thickness of the interface layer 100. However, it should be understood that the recesses 104 can have different widths and different depths from the top surface of the interface layer 100, as long as each of the recesses 104 has a prescribed width and depth of about 5% to 10% of the thickness of the interface layer 100. Preferably, each of the recesses 104 has a prescribed width and depth of 0.5 nm to 200 nm. The distance between each of the recesses 104 in the x direction ranges from 0.5 nm to 200 nm.

By providing the interface layer 100, unwanted reactions between the current collector 102 and lithium in an electrode active material can be reduced, thereby preventing dendrite growth and improving the safety and performance of a battery containing the interface layer 100. Furthermore, by providing the recesses 104 in the surface of the interface layer 100, adhesion between the current collector 102 and an electrode active material containing lithium can be improved, thus preventing undesirable peeling off of the electrode active material layer from the current collector 102 and decreasing the resistance while improving the cyclability of the battery.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An electrode comprising:
a current collector;
an electrode active material layer; and
an interface layer disposed between the current collector and the electrode active material layer,
the electrode active material layer comprising an electrode active material including lithium,
the interface layer comprising a transition metal oxide including oxygen and at least one transition metal, and
the interface layer having a surface in contact with the electrode active material layer and at least one recess formed in the surface.

2. The electrode according to claim 1, wherein
the current collector is formed of at least one of copper and aluminum.

3. The electrode according to claim 1, wherein
the electrode active material includes at least one selected from the group consisting of: lithium metal and a lithium alloy.

4. The electrode according to claim 1, wherein
the transition metal oxide is at least one selected from the group consisting of: aluminum oxide, zinc oxide and zirconium oxide.

5. The electrode according to claim 1, wherein
the surface of the interface layer includes the at least one recess and at least one flat portion on opposite sides of each of the at least one recess.

6. The electrode according to claim 5, wherein
a first layer is disposed on each of the at least one recess.

7. The electrode according to claim 6, wherein
the first layer comprises zinc.

8. The electrode according to claim 5, wherein
a second layer is disposed on each of the at least one flat portion.

9. The electrode according to claim 8, wherein
the second layer comprises a noble metal.

10. A battery comprising
a cathode;
an anode; and
an electrolyte disposed between the cathode and the anode,
at least one of the anode and the cathode comprising:
a current collector;
an electrode active material layer; and
an interface layer disposed between the current collector and the electrode active material layer,
the electrode active material layer comprising an electrode active material including lithium,
the interface layer comprising a transition metal oxide including oxygen and at least one transition metal, and
the interface layer having a surface in contact with the electrode active material layer and at least one recess formed in the surface.

11. The battery according to claim 10, wherein
the current collector is formed of at least one of copper and aluminum.

12. The battery according to claim 10, wherein
the electrode active material includes at least one selected from the group consisting of: lithium metal and a lithium alloy.

13. The battery according to claim 10, wherein
the transition metal oxide is at least one selected from the group consisting of: aluminum oxide, zinc oxide and zirconium oxide.

14. The battery according to claim 10, wherein
a dopant layer is disposed on at least a portion of the surface of the interface layer, the dopant layer comprising at least one selected from the group consisting of: zinc and a noble metal.

15. The battery according to claim 14, wherein
the dopant layer has a smaller thickness than the electrode active material layer.

16. The battery according to claim 10, wherein
the electrolyte includes at least one of: a solid polymer electrolyte, and a solid state electrolyte comprising sulfide.

17. The battery according to claim 10, wherein
the at least one recess extends along an entire length of the interface layer.

18. The battery according to claim 10, wherein
the at least one recess includes a plurality of recesses formed at discrete locations along a length of the interface layer.

19. The battery according to claim 10, wherein
the interface layer has a thickness of approximately 10 μm to 100 μm.

20. The battery according to claim 10, wherein
the dopant layer includes a first layer formed on each of the at least one recess and a second layer formed on each of a plurality of flat portions formed on opposite sides of the at least one recess.
